(19) United States
(12) Patent Application Publication
(10) Pub. No.: US 2019/0353461 A1
(43) Pub. Date: Nov. 21, 2019

(54) HYBRID TACTICAL RAILS WITH SLOW SPEED AND HIGH SPEED DATA BUSES

(71) Applicants: Sensors Unlimited, Inc., Princeton, NJ (US); The United States of America, as represented by the Secretary of the Army, Washington, DC (US)

(72) Inventors: Henry William Neal, Aliso Viejo, CA (US); Mark Sproul, Picatinny Arsenal, NJ (US)

(21) Appl. No.: 15/983,045

(22) Filed: May 17, 2018

(51) Int. Cl. F41G 11/00; H01R 13/24

(52) U.S. Cl. CPC F41G 11/003; H01R 13/2464

(57) ABSTRACT

A tactical rail for a firearm includes a rail body having a receiver end and a muzzle end and a non-contact optical connection arranged at an end of the rail body and configured to interface with a corresponding non-contact optical interface. A low speed data bus segment extends between the receiver end and the muzzle end of the rail body. A high speed data spoke is connected to the non-contact optical connection for high speed data communication with a high speed data accessory through the non-contact optical connection and the corresponding non-contact optical interface. Tactical rail systems and firearm assemblies having tactical rails are also described.

### FEDERAL RESEARCH STATEMENT

This invention was made with Unites States government support from the Department of the Army. The government has certain rights in the invention.

### BACKGROUND OF THE INVENTION

### 1. Field of the Invention

The present disclosure relates to firearms, and more particularly to firearm tactical rails with low speed and high speed data buses for accessories removably fixed to the tactical rail.

### 2. Description of Related Art

Firearms, such as assault rifles, commonly include accessory rails. Accessory rails generally conform to a rail standard, for example, MIL-STD-1913, Weaver, NATO STANAG 4694 accessory rails, and are designed to allow a user to attach and detach various accessories to firearms. Firearms fitted with accessory rails in turn can be readily kitted with various accessories that conform to the particular accessory rail standard, such as with telescopic sights, tactical sights, laser sighting modules, night vision devices, and range finders, thereby enhancing or provide additional capability to the firearm. In some cases a user can add accessories to the firearm using an accessory rail without specialized tools or training.

Some firearm accessories require electrical power and/or connectivity for data communication. To accommodate the need for electrical power some accessory rails include power distribution capability for providing electrical power to accessories through the accessory rail. To accommodate the need for connectivity some accessory rails include integral data links. Integral data links are generally limited to low speed data communication, accessories requiring high speed data connectivity typically provisioned with coaxial cables or wireless transceivers to provide additional bandwidth for higher data rates of data communication.

Such conventional methods and systems have generally been considered satisfactory for their intended purpose. However, there is still a need in the art for improved tactical rails and tactical rail arrangements. The present disclosure provides a solution for this need.

### SUMMARY OF THE INVENTION

A tactical rail for a firearm includes a rail body having a receiver end and a muzzle end and a non-contact optical connection arranged at an end of the rail body and configured to interface with a corresponding non-contact optical interface. A low speed data bus segment extends between the receiver end and the muzzle end of the rail body. A high speed data spoke is connected to the non-contact optical connection for high speed data communication with a high speed data accessory through the non-contact optical connection and the corresponding non-contact optical interface.

In certain embodiments the tactical rail can include a power source. The power source can be electrically connected to the low speed data bus segment. A user interface accessory electrically connected to the low speed data bus. The user interface accessory can receive electrical power form the low speed data bus. The user interface can receive low speed data from the low speed data bus. The user interface accessory can be optically coupled to the high speed data spoke by the non-contact optical connection. The user interface can include an optical switch for switching high speed data between a plurality of high speed data spokes.

In accordance with certain embodiments, the low speed data bus segment can include two or more electrical conductors extending between the muzzle and receiver ends of the rail body. The low speed data bus segment includes a plurality of contact electrical connectors arranged axially between the muzzle end and the receiver end of the rail body. The plurality of contact electrical connections can includes a pair of pogo pad-type contact electrical connectors arranged at a common axial location between the muzzle end and the receiver end of the rail body.

It is contemplated that, in accordance with certain embodiments, the high speed data spoke can include an optical waveguide. The high speed data spoke can include a fiber optic or fiber optic bundle, a glass light pipe, or a plastic light pipe. An accessory detector co-located with the non-contact optical connection. A contact electrical connection can be co-located with the non-contact optical connection and electrically connected to the bus segment. A contact electrical connection can be arranged between the receiver end and the muzzle end of the rail body. A contact electrical connection can be arranged at the receiver end of the tactical rail. A contact electrical connection can be arranged at the muzzle end of the tactical rail. The low speed data bus segment can electrical connect one or more contact electrical connections arranged between the receiver end and the muzzle end of the rail body with contact electrical connections arranged at the receiver end and/or the muzzle end of the rail body.

A tactical rail arrangement includes an upper tactical rail as described above and a left or right tactical rail as described above. The non-contact optical connection of the upper tactical rail is arranged on the muzzle end of the upper tactical rail. The upper tactical rail includes first and second receiver end non-contact optical connections, the upper tactical rail high speed data spoke optically coupling the muzzle end non-contact optical connection to the first receiver end non-contact optical connection, and the high speed data spoke of the left or right tactical rail optically coupling the non-contact optical connection of the left or right tactical rail to the second receiver end non-contact optical connection.

In certain embodiments the low speed data bus segment of the left or right tactical rail can be electrically connected to the low speed data bus segment of the upper tactical rail. A high speed data user interface accessory can be electrically connected to the slow speed data bus segment of the upper tactical rail and the slow speed data bus segment of the left or right bus segment. The user interface accessory can be optically coupled to the first and second receiver end non-contact connections of the upper tactical rail.

In accordance with certain embodiments, the upper tactical rail can include a contact electrical connection co-located with the upper tactical rail receiver end non-contact optical connection. A contact electrical connection can be co-located with the upper tactical rail muzzle end non-contact optical connection. Two or more contact electrical connections can be arranged between the receiver end and the muzzle end of the upper tactical rail. The low speed data bus segment can electrically connect the contact electrical connection co-located with the upper tactical rail receiver end non-contact optical connection, the contact electrical connection co-located with the upper tactical rail muzzle end non-contact optical connection, and the two or more contact electrical connections arranged between the receiver end and the muzzle end of the upper tactical rail with one another.

It is also contemplated that, in accordance with certain embodiments, the left or right tactical rail can include a contact electrical connection co-located with the left or right tactical rail non-contact optical connection. Two or more contact electrical connections can be arranged between the receiver end and the muzzle end of the left or right tactical rail. The low speed data bus segment of the left or right tactical rail can electrically connect the contact electrical connection co-located with the left or right tactical rail non-contact optical connection and the a plurality of contact electrical connections arranged between the receiver end and the muzzle end of the left or right tactical rail.

A firearm assembly includes a firearm having a muzzle and a receiver and tactical rail as described above. The tactical rail is fixed to the firearm between the muzzle and the receiver of the firearm, the non-contact optical connection is arranged at the receiver end of the tactical rail, and a muzzle end non-contact optical connection is arranged at the muzzle end of the rail body. The high speed data spoke connects the muzzle end non-contact optical connection with the receiver end non-contact optical connection and a high speed data user interface accessory is removably fixed at the receiver end of the tactical rail and in optical communication with the muzzle end non-contact optical connection through the receiver end non-contact optical connection.

In certain embodiments a high speed data accessory can be removably fixed to muzzle end of the rail body. The high speed data accessory can be optically coupled to the user interface accessory by the high speed data spoke. The accessory can be electrically connected to the user interface accessory by the low speed data bus segment. In accordance with certain embodiments a low speed data accessory can be removably fixed to the tactical rail between the receiver end and the muzzle end of the rail body. The low speed data accessory can be electrically connected to the user interface accessory by the low speed data bus segment.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an exemplary embodiment of a firearm assembly, showing a tactical rail arrangement and accessories removably fixed to the firearm by the tactical rail arrangement, the accessories requiring power and connectivity for data communications;

FIG. 2 is a schematic diagram of a power bus routed through the tactical rail arrangement of FIG. 1, showing the power bus topology and accessories powered by the power bus;

FIG. 3 is a schematic diagram of a low speed data bus routed through the tactical rail arrangement of FIG. 1, showing the low speed data bus topology and accessories having low speed data connectivity with one another through the low speed data bus;

FIG. 4 is a schematic view of a portion of a tactical rail of the tactical rail arrangement of FIG. 1, showing a rail portion with contact electrical connections for connecting accessories to the power bus for powering and providing low speed data communication to the accessories;

FIG. 5 is a schematic diagram of a high speed data bus routed through the tactical rail arrangement shown in FIG. 1, showing the high speed data bus topology and accessories having high speed data connectivity with one another through the high speed data bus;

FIG. 6 is a schematic view of a portion of a tactical rail of the tactical rail arrangement of FIG. 1, showing a rail portion including a hot shoe to provide optical communication and electrical communication to a user interface accessory serving as the hub for the high speed data and the low speed data bus;

FIG. 7 is a side elevation view of the user interface accessory of FIG. 1, showing the user interface removably fixed to an upper tactical rail of the tactical rail arrangement at the hot shoe;

FIG. 8 is a schematic diagram of a hybrid data bus routed through both a low speed data bus and a high speed data bus within of the tactical rail arrangement, showing the user interface arranged as the hub of the high speed data bus and as a terminal in the low speed data bus;

FIG. 9 is an exploded view of the firearm assembly of FIG. 1, showing the upper tactical rail, the right tactical rail, and the left tactical rail and accessories exploded away from the firearm;

FIGS. 10 and 11 are schematic and plan views of the upper tactical rail of FIG. 1, showing non-contact optical connections arranged at the muzzle and receiver ends of the rail body and contact electrical connections arranged along the rail body of the upper tactical rail;

FIGS. 12 and 13 are schematic and plan views of the left tactical rail of FIG. 1, showing a non-contact optical connection arranged at the muzzle end of the left tactical rail and contact electrical connections arranged along the rail body of the left tactical rail;

FIGS. 14 and 15 are schematic and plan views of the right tactical rail of FIG. 1, showing a non-contact optical connection arranged at the muzzle end of the right tactical rail and contact electrical connections arranged along the rail body of the right tactical rail;

FIG. 16 is a plan view of another tactical rail arrangement of FIG. 1, showing connectivity of the high speed data spokes and power bus across the upper tactical rail, the left tactical rail and the right tactical rail, the right tactical rail having a non-contact optical connection at the receiver end of the right tactical rail; and

FIG. 17 is a schematic view of the tactical rail arrangement of FIG. 1, showing the high speed data spokes and power bus connected to high speed data accessories of a firearm assembly.

### DETAILED DESCRIPTION OF THE PREFERRED EMBODIMENTS

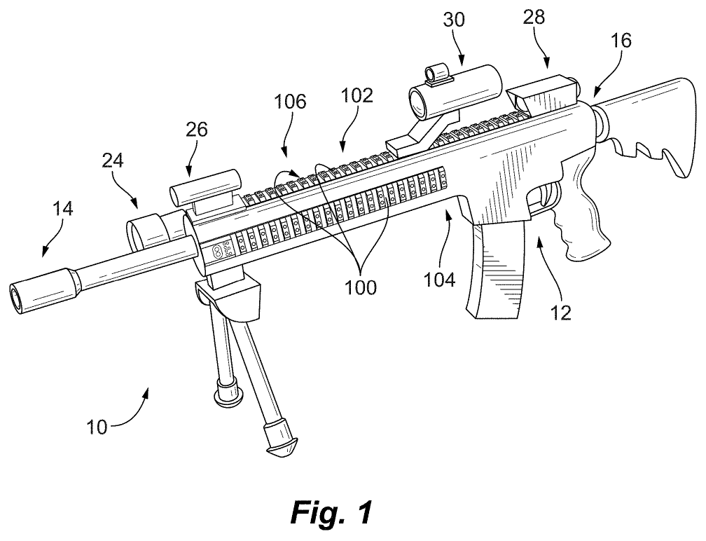

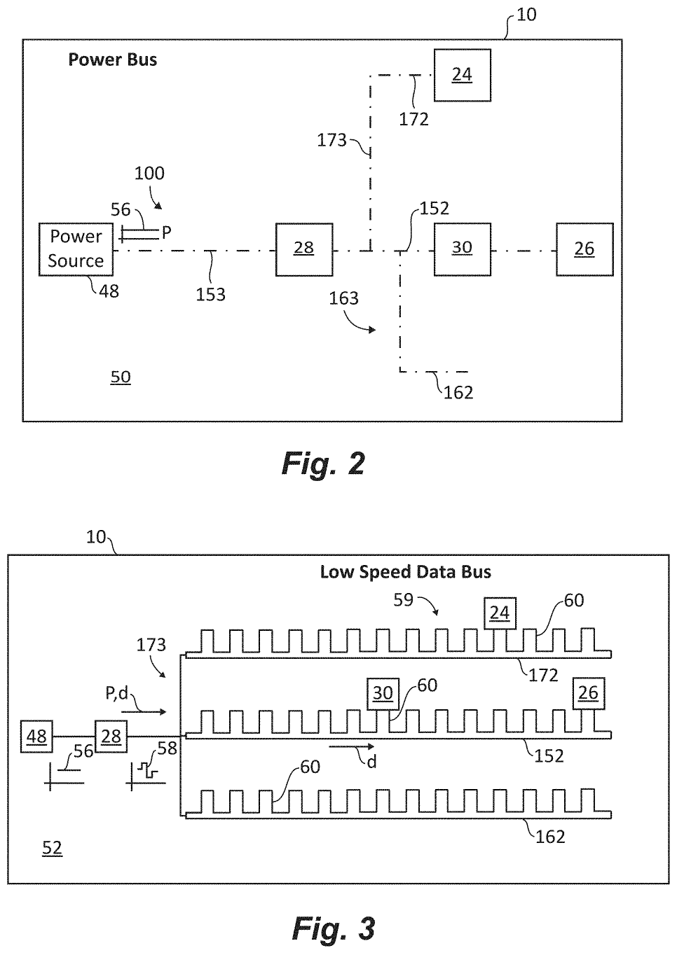

Reference will now be made to the drawings wherein like reference numerals identify similar structural features or aspects of the subject disclosure. For purposes of explanation and illustration, and not limitation, a partial view of an exemplary embodiment of a tactical rail arrangement in accordance with the disclosure is shown in FIG. 1 and is designated generally by reference character 100. Other embodiments of tactical rails, tactical rail arrangements, and firearm assemblies having tactical rails and tactical rail arrangements in accordance with the disclosure, or aspects thereof, are provided in FIGS. 2-17, as will be described. The systems and methods described herein can be used for providing connectivity for high speed data communication to firearm accessories, such as for imaging or video accessories, though the present disclosure is not limited to accessories requiring connectivity for high speed data communication in general.

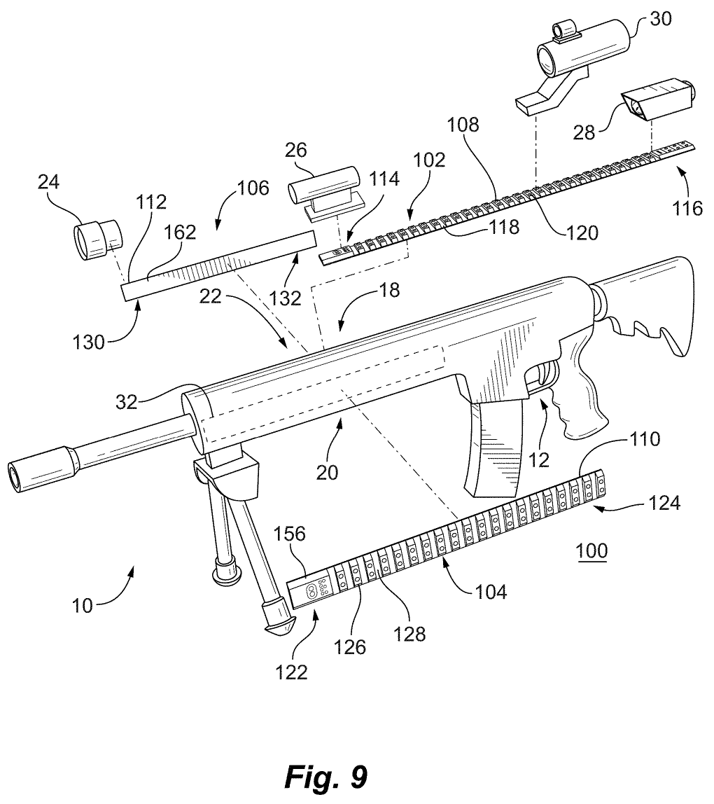

Referring to FIG. 1, a firearm assembly 10 is shown. Firearm assembly 10 includes a firearm 12. Firearm 12 includes standard components such as a receiver, a grip, a barrel, a handguard 30 (shown in FIG. 9), and a butt stock, a muzzle 14 and a receiver 16. Muzzle 14 and receiver 16 are arranged at opposite ends of firearm 12. Tactical rail arrangement 100 includes at least a first tactical rail and a second tactical rail, e.g., two or more of an upper tactical rail 102, a left-hand (left) tactical rail 104, and a right-hand (right) tactical rail 106, each of which are configured for attachment to firearm 12. It is contemplated that one or more of the tactical rails be interchangeable with a handguard of firearm 12, e.g., handguard 32.

One or more high speed data accessories, e.g., accessories 24-30, are removably fixed to tactical rail arrangement 100. As shown in FIG. 1, tactical rail arrangement 100 removably fixes each of an illuminator accessory 24, a camera accessory 26, a user interface accessory 28, and a telescopic sight accessory 30 to firearm 12 to integrate each with firearm 12 to form firearm assembly 10. It is contemplated that firearm assembly 10 include fewer than four (4) or more than four (4) accessories, as suitable for an intended application. In certain embodiments accessory 30 can be a low speed data accessory, such a legacy device requiring a data rate below 200 megabits per second by way of example.

As will be appreciated by those of skill in the art in view of the present disclosure, some firearm accessories require electrical power and/or connectivity for data communications. In this respect connectivity can be necessary for low speed data communication, e.g., data rates of about 200 megabits per second and slower. Connectivity can also be necessary for high speed data communication, e.g., data rates of about one gigabyte per second and higher. To accommodate the requirements for electrical power and connectivity tactical rail arrangement 100 includes a power bus 50 (shown in FIG. 2) to provide electrical power to accessories 24-30, a low speed data bus 52 (shown in FIG. 3) with a bus topology 59 (shown in FIG. 3) to provide connectivity for low speed data communication to one or more of accessories 24-30, and a high speed data bus 54 (shown in FIG. 5) to provide connectivity for high speed data communication to one or more of accessories 24-30. In certain embodiments tactical rail arrangement 100 can include a hybrid data bus 74 (shown in FIG. 8) to provide connectivity for both low speed communication and high speed data communication between accessories removably fixed to tactical rail arrangement 100.

With reference to FIG. 2, power bus 50 is shown. Power bus 50 is configured to provide electrical communication between a power source 48 and accessories 24-30 removably fixed to firearm 12 by tactical rail arrangement 100. In this respect power bus 50 includes an upper rail bus segment 152, a left rail bus segment 162, and a right rail bus segment 172. Power bus 50 also includes an upper rail power lead 153, a left rail crossover segment 163, and a right rail crossover segment 173.

Upper rail bus segment 152 is fixed within upper tactical rail 102 (shown in FIG. 1). Left rail bus segment 162 and right rail bus segment 172 are fixed within left tactical rail 104 (shown in FIG. 1) and right tactical rail 106 (shown in FIG. 1), respectively. Left rail crossover segment 163 connects left rail bus segment 162 with upper rail bus segment 152. Right rail crossover segment 173 connects right rail bus segment 172 with upper rail bus segment 152. Upper rail power lead 153 connects a power source 48 to power bus 50, thereby providing DC power 56 to upper rail bus segment 152, left rail bus segment 162, and right rail bus segment 172 through left rail crossover segment 163 and right rail crossover segment 173.

Accessories 24-30 are electrically connected to the rail bus segments. In the illustrated exemplary arrangement accessory 24 is electrically connected to right rail bus segment 172. Accessory 26, accessory 30, and user interface accessory 28 are each electrically connected to upper rail bus segment 152. Power source 48 can be a remote power source, e.g., not carried by firearm assembly 12, such as a battery, and can be arranged within the stock of firearm 12.

With reference to FIG. 3, low speed data bus 52 is shown. Low speed data bus 52 has a bus topology 59 and is implemented using the bus segments of power bus 50 (shown in FIG. 2). In this respect bus topology 59 includes upper rail bus segment 152, left rail bus segment 162, and right rail bus segment 172. Bus topology 59 also includes left rail bus crossover segment 163 and right rail bus crossover segment 173 which, in cooperation with upper rail bus segment 152, left rail bus segment 162, and right rail bus segment 172, define low speed data bus 52.

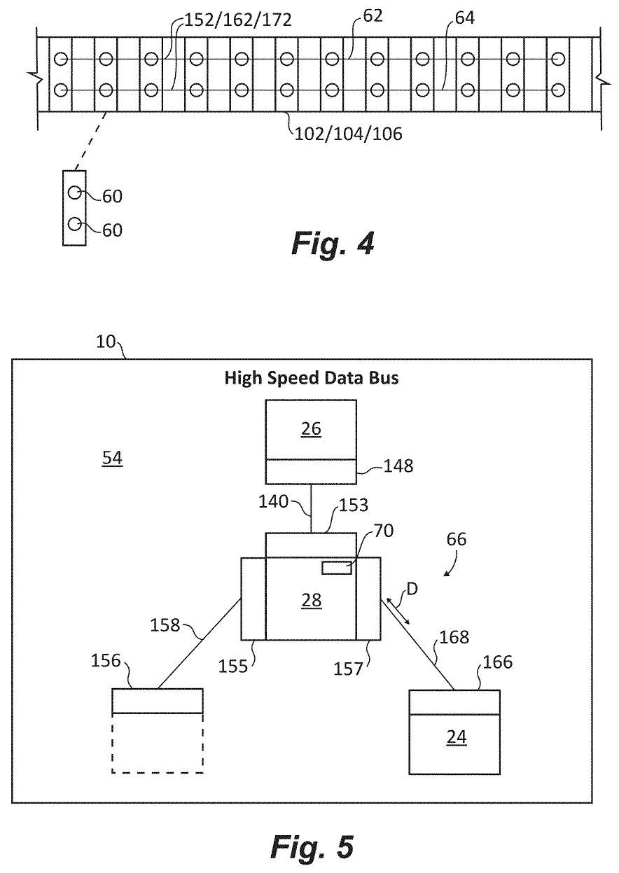

Exemplary portions of rails 102/104/106 having bus segments 152/162/172 are shown in FIG. 4, rail bus segments 152/162/172 including electrical conductors 62/64 electrically connecting contact electrical connections 60 in series with one another to provide power and connectivity for low speed data communication d. Contact electrical connections 60 can be pogo pad-type electrical connections 61 having positive and negative pads located at a common axial location between the muzzle end and the receiver end of the respective tactical rail.

To provide connectivity for low speed data communication over low speed data bus 52 a power modulation method is employed. In this regard user interface accessory 28 receives constant frequency power 56 from power source 48, modulates constant frequency power 56 to include data, and provides the power as modulated power 58 to accessories removably fixed to tactical rail arrangement 100 through low speed data bus 52. Low speed data bus conveys 52 conveys modulated power to the accessories, thereby broadcasting data for addressed for individual accessories to each accessory removably fixed to tactical rail arrangement 100 as low speed data d in conjunction with power P. Examples of systems and methods of low speed data communication include Intelligent Rail® data rail systems, available from T-Worx Holdings LLC of Ashburn, Va.

While generally acceptable for their intended purpose, i.e., low speed data with data rates generally less than 200 megabytes per second, higher data rates can require relatively complex electronics for signal processing. To avoid the need for such electronics and provide high data rate communication suitable for imaging and/or video accessories, tactical rail arrangement 100 includes high speed data bus 54.

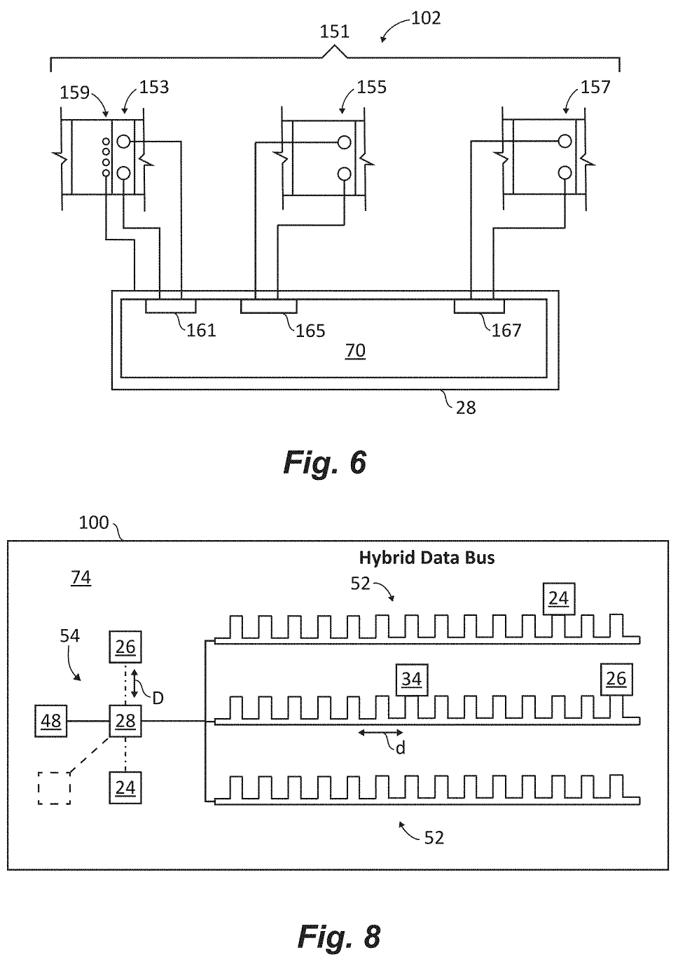

Referring to FIG. 5, high speed data bus 54 is shown. High speed data bus 54 includes a star topology 66 to provide connectivity to high speed data accessories removably fixed to tactical rail arrangement 100 (shown in FIG. 1). In this respect high speed data bus 54 includes an upper spoke 140, a left spoke 158, and a right spoke 168, each of which can include a crossover spoke and/or a rail spoke according to arrangement of the particular tactical rail. High speed data bus 54 also includes a right rail non-contact optical connection 166, a left rail non-contact optical connection 156, and a hot shoe 151 (shown in FIG. 6). Hot shoe 151 in turn has first receiver end non-contact optical connection 153, a second receiver end non-contact optical connection 155, and a third receiver end non-contact optical connection 157. Examples of suitable non-contact optical connections include those described in U.S. Patent Application Publication No. 2017/0122706 A1 to Masarik et al., filed on Nov. 2, 2016, the contents of which are incorporated herein by reference in its entirety.

Upper spoke 140 is fixed to upper tactical rail 102 (shown in FIG. 1) and connects first receiver end non-contact optical connection 153 with a muzzle end non-contact optical connection 148. Left spoke 158 is fixed to left tactical rail 104 (shown in FIG. 1) and connects second receiver end non-contact optical connection 155 with left rail non-contact optical connection 156. Right spoke 168 is fixed to right tactical rail 106 (shown in FIG. 1) and connects third receiver end non-contact optical connection 157 with right rail non-contact optical connection 166.

User interface accessory 28 includes an optical switch 70 and is removably fixed at hot shoe 151 (shown in FIG. 6). Hot shoe 151 provides optical communication to user interface accessory 28 through first receiver end non-contact optical connection 153, second receiver end non-contact optical connection 155, and third receiver end non-contact optical connection 157. Optical switch 70, contained within user interface accessory 28, routes high speed data D between accessories removably fixed to rail arrangement 100 (shown in FIG. 1) and in optical communication with one another through non-contact optical connections arranged on hot shoe 151, the muzzle end of upper tactical rail 102 (shown in FIG. 1), and arranged on the receiver end or muzzle end of left tactical rail 104 (shown in FIG. 1) and/or right tactical rail 106 (shown in FIG. 1).

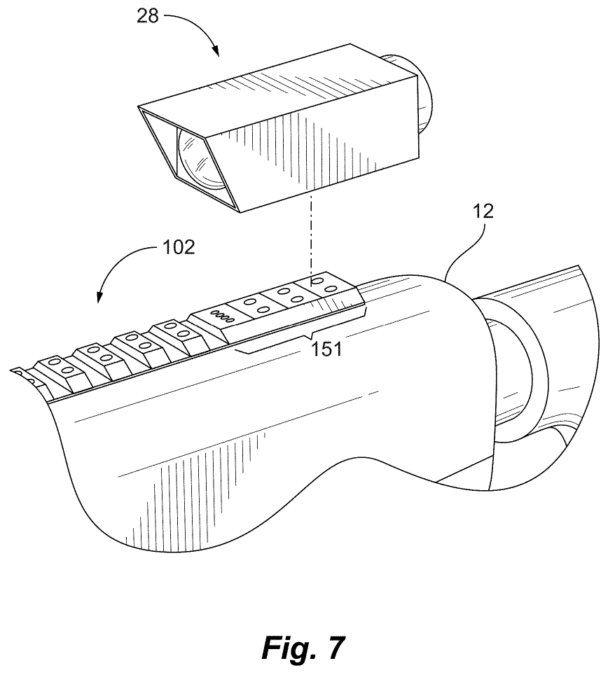

With reference to FIGS. 6 and 7, connectivity between user interface accessory 28 and hot shoe 151 is shown. Hot shoe 151 is arranged on upper tactical rail 102 at receiver end 116 (shown in FIG. 1) and includes a first receiver end non-contact optical connection 153, a second receiver end non-contact optical connection 155, a third receiver end non-contact optical connection 157, and a contact electrical connection 159. User interface 28 is removably fixed to upper tactical rail 102 at hot shoe 151 and includes a three corresponding non-contact optical interfaces. In this respect a first non-contact optical interface 161 of user interface accessory 28 corresponds to first receiver end non-contact optical connection 153, a second non-contact optical interface 165 of user interface accessory 28 corresponds to a second receiver end non-contact optical connection 155, and a third non-contact optical interface 167 of user interfaced accessory 28 corresponds to third receiver end non-contact optical connection 157 to provide optical communication between user interface accessory 28 and accessories removably fixed to non-contact optical connections arranged on tactical rail arrangement 100 via optical switch 70.

As also shown in FIG. 6, user interface accessory 28 also includes an electrical interface for electrical communication with contact electrical connection 159, which provides electrical power to user interface accessory 28. In certain embodiments the electrical interface provides connectivity for data communication between low speed data bus 52 and high speed data bus 54, user interface accessory 28 serving a gateway terminal between low speed data bus 52 and high speed data bus 54 in a hybrid bus topology 74 (shown in FIG. 8).

With reference to FIG. 8, hybrid bus topology 74 is shown. Hybrid bus topology 74 includes low speed data bus 52 and high speed data bus 54 connected to one another through user interface accessory 28. Low speed data bus 52 is connected to high speed data bus 54 at hot shoe 151, user interface 28 connecting to low speed data bus 52 through contact electrical connection 159 (shown in FIG. 6) and to high speed data bus 54 through one or more of non-contact optical connections 153/155/157 (shown in FIG. 6). Connection to both low speed data bus 52 and high speed data bus 54 allows user interface accessory 28, through operation of optical switch 70 as circuitry, to both switch high speed data D between spokes of high speed data bus 54 as well as operate a gateway to low speed data bus 52 to receive and pass low speed data therethrough.

Advantageously, all switching occurs outside of tactical rail arrangement 100 and within user interface accessory 28. In certain embodiments tactical rail arrangement 100 can include no electronics within the tactical rails themselves, reducing (or eliminating entirely) the need to remove tactical rails from firearm 12 to troubleshoot problems with either low speed data bus 52 and/or high speed data bus 54. This allows a user to troubleshoot connectivity among the accessories by switching out accessories removably fixed to tactical arrangement 100, e.g., by replacing user interface accessory 28.

With reference to FIG. 9, firearm assembly 10 is shown with the tactical rails of tactical rail arrangement 100 exploded away from firearm 12. Upper tactical rail 102 has a rail body 108 configured to seat on an upper side 18 of firearm 12. Left tactical rail 104 has a rail body 110 configured to seat on a left side 20 of firearm 12. Right tactical rail 106 has a rail body 112 configured to seat on a right side 22 of firearm 12. One or more of rail body 108, rail body 110, and/or rail body 112 is interchangeable with a handguard 32 of firearm 12. As shown in FIG. 9 rail body 108 is configured for fixation to firearm 12 as an upper tactical rail, rail body 110 is configured for fixation to firearm 12 a left tactical rail, rail body 112 is configured for fixation to firearm 12 as a right tactical rail, and each of accessories 24-30 are configured for removable fixation to any one of upper tactical rail 102, right tactical rail 104, and left tactical rail 106.

Rail body 108 extends between a muzzle end 114 and a receiver end 116. Between muzzle end 114 and receiver end 116 rail body 108 defines a plurality of ribs 118 and slots 120. Ribs 118 and slots 120 are axially spaced apart from one another along rail body 108 between muzzle end 114 and receiver end 116.

Ribs 118 and slot 120 are configured and adapted to removably fix accessories to firearm 12. For example, rail body 108 can include a bracket used on some firearms to provide a standardized accessory mounting platform for removably fixing accessories to rail body 108. Alternatively, rail body 108 has a series of ridges with a T-shaped cross-section interspersed with flat “locking slots” (also termed “recoil groove”). Accessories can be removably fixed either by sliding the accessory from one end of rail body 108 toward the opposite end of rail body 108, establishing electrical contact between the accessory and a contact electrical connection arranged along rail body 108, and fixing the accessory to rail body 108 by manipulating a “rail-grabber” which is clamped to rail body 108 with bolts, thumbscrews, or levers, or onto the slots between ribs 118.

In certain embodiments rail body 108 conforms to a Weaver rail system standard. In accordance with certain embodiments rail body 108 conforms to a Warsaw Pact rail system standard. In further embodiments rail body 108 conforms to a KeyMod rail system standard or an M-LOK rail system standard. It is also contemplated that rail body 108 conforms to a NATO STANAG 4694 rail system standard, or a MIL-STD-1913 rail system standard. In this respect rail body 108 can conform to MIL-STD-1913 (NOTICE 2), MILITARY STANDARD: DIMENSIONING OF ACCESSORY MOUNTING RAIL FOR SMALL ARMS WEAPONS (3 Oct. 2013) and/or MIL-STD-1013, dated 20 Apr. 2004, each of which are incorporated herein by reference in their entirety.

Rail body 110 of left tactical rail 104 is similar to rail body 108 of upper tactical rail 102 with the differences that rail body 110 includes single non-contact optical connection 156. In this respect rail body 110 extends longitudinally between a muzzle end 122 and a receiver end 124 and is configured and adapted to be fixed to left side 20 of firearm 12. Between muzzle end 122 and receiver end 124 rail body 110 defines a plurality of ribs 126 and slots 128 that are axially spaced apart from one another along rail body 110 between a muzzle end 122 and receiver end 124.

As with ribs 118 and slots 120, ribs 126 and slots 128 are configured and adapted to removably fix accessories to rail body 108, e.g., to a Weaver rail system standard, a Warsaw Pact rail system standard, a KeyMod rail system standard, an M-LOK rail system standard, a MIL-STD-1913 rail system standard, or a NATO STANAG 4694 rail system standard. Rail body 112 of right tactical rail 106 is similar to rail body 110 of right rail body 112 with the difference that rail body 112 extends between a muzzle end 130 and a receiver end 132 and is configured and adapted to be fixed to right side 22 of firearm 12.

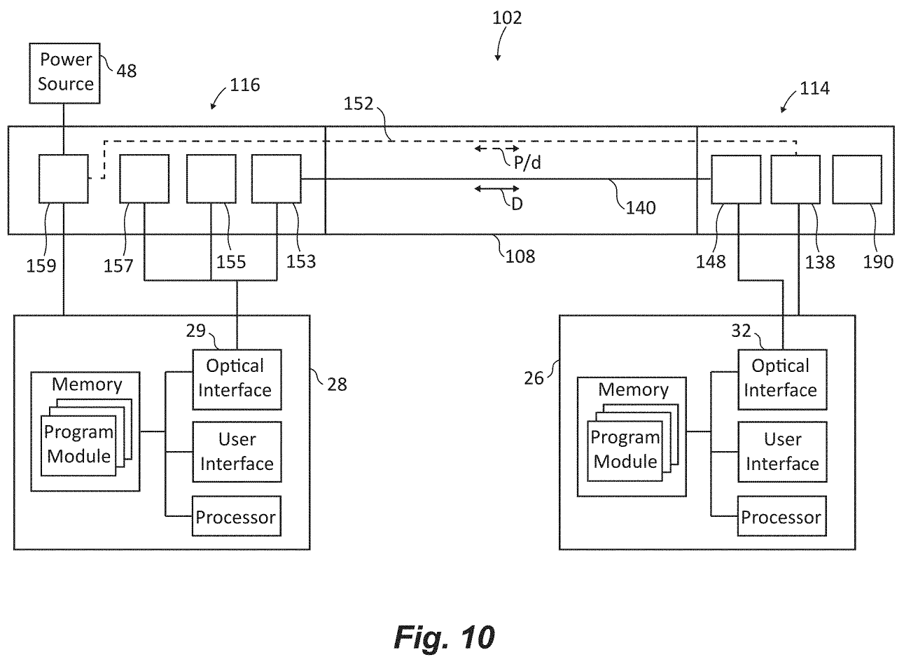

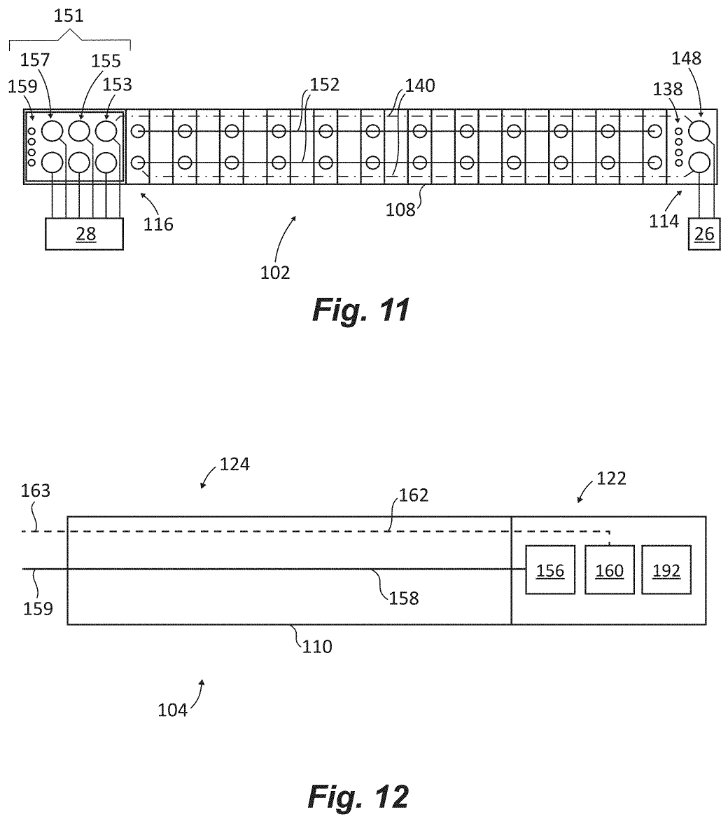

With reference to FIGS. 10 and 11, upper tactical rail 102 is shown. Referring to FIG. 10, upper tactical rail 102 includes rail body 108 with receiver end 116 and opposed muzzle end 114. Non-contact optical connection 148 is arranged at muzzle end 114 to optically couple with a corresponding non-contact optical interface, e.g., a non-contact optical interface 32, of accessory 26. First receiver end non-contact optical connection 153, second receiver end non-contact optical connection 155, and third receiver end non-contact optical connection 157 are each arranged at receiver end 116 of rail body 108 to optically couple with corresponding non-contact optical interfaces 29 of user interface accessory 28, thereby providing high speed data communication D (shown in FIG. 10) with accessories removably fixed to tactical rail arrangement 100. High speed data spoke 140 connects first receiver end non-contact optical connection 153 with non-contact optical connection 148 for passing high speed data D (shown in FIG. 10) between accessory 26 and user interface 28, and is a rail spoke fixed within upper tactical rail 102.

It is contemplated that rail spoke 140 of upper tactical rail 102 be an optical waveguide. In certain embodiments rail spoke 140 can include a fiber optic or fiber optic bundle, a glass light pipe, or a plastic light pipe by way on non-limiting example. As shown in FIG. 11, rail spoke 140 can include a plurality of optical waveguide to allow user interface accessory 28 and accessory 26 to send and receive high speed data D between one another at the same time. It is also contemplated that upper tactical rail 102 can include optical-electrical signal converter connected to non-contact optical connection 148 and first receiver end non-contact optical connection 153, rail spoke 140 being a conductor electrically connecting the optical-electrical converters.

Upper tactical rail 102 also includes a muzzle end contact electrical connection 138, a receiver end contact electrical connection 159, and upper rail bus segment 152. Muzzle end contact electrical connection 138 is co-located with muzzle end non-contact electrical connection 148 to provide electrical power P and/or low speed data communication d accessory 26 when removably fixed to muzzle end 114 of upper tactical rail 102. Receiver end contact electrical connection 159 is arranged within hot shoe 151 at receiver end 116 of upper tactical rail 102 to provide electrical power P and/or low speed data communication d to user interface accessory 28. Upper rail bus segment 152 electrically connects muzzle end electrical connection 138 with receiver end contact electrical connection 159 for communicating electrical power P from power source 48 to user interface accessory 28 and accessory 26 and/or low speed data d between user interface accessor 28 and accessory 26 when removably fixed to muzzle end 114 of upper tactical rail 102.

In certain embodiments upper rail bus segment 152 also communicates low speed data d between user interface 28 and accessory 26 through muzzle end electrical connection 138 and receiver end contact electrical connection 159. As shown in FIG. 11, upper tactical rail 102 can have a plurality of contact electrical connection 60. The plurality of contact electrical connection 60 are arranged axially along rail body 108 between muzzle end 114 and receiver end 116. It is contemplated that contact electrical connection 60 can include pogo pad-type contact electrical connections 61, each pogo pad pair include a positive contact and a negative contact accessible to an accessory removably fixed to rail body 108 between muzzle end 114 and receiver end 116. This provides connectivity for low speed data connectivity for legacy devices, e.g., accessory 30 (shown in FIG. 1), that otherwise may be unable to communicate via high speed data bus 54 (shown in FIG. 5)

Referring again to FIG. 10, upper tactical rail 102 can include an accessory detector 190. Accessory detector 190 is co-located with non-contact optical connection 148 and muzzle end contact electrical connection 138 on muzzle end 114 of upper tactical rail 102. Accessory detector 190 is configured to detect whether an accessory is removably fixed to upper tactical rail 102 at muzzle end 114. In this respect accessory detector 190 has an accessory-detected state and a no accessory-detected state.

In the accessory-detected state accessory detector 190 allows optical communication between first receiver end non-contact optical connection 153 and muzzle end non-contact optical connection 148. This allows user interface accessory 28 and accessory 26 to pass high speed data D between one another. In the no accessory-detected state accessory detector 190 prevents user interface accessory 28 from optically communicating with muzzle end non-contact optical connection 148, reducing (or eliminating entirely) the risk that light emitted therethrough could pose to a user. Communication between accessory detector 190 and user interface can be, for example, via upper rail bus segment 152. Accessory detector 190 can be implemented with, for example, with a hall-effect sensor, a pressure sensor, or a proximity sensor by way of non-limiting example. In certain embodiments change of state cause accessory detector 190 to initiate (or cease) optical communication between user interface accessory 28 and non-contact optical connection 148.

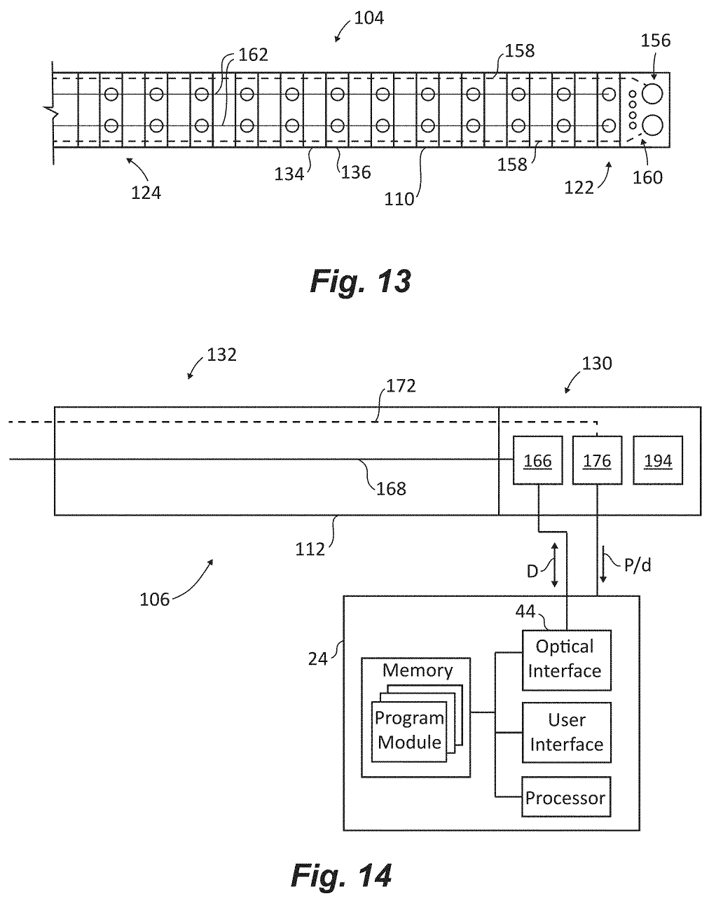

With reference to FIGS. 12 and 13, left tactical rail 104 is shown. Left tactical rail 104 is similar to upper tactical rail 102 (shown in FIG. 1) with the differences that left tactical rail 104 has a rail body 110 arranged to attach to left side 22 (shown in FIG. 9) of weapon 12 (shown in FIG. 1), has a single non-contact optical connection 156, includes a low speed crossover segment 163, and a high speed crossover spoke 159. Rail body 110 extends between muzzle end 122 and receiver end 124. Non-contact optical connection 156 is arranged at muzzle end 130 and is configured to interface with a corresponding non-contact optical interface. Low speed crossover segment 163 is electrically connected bus segment 152 and contact electrical connection 159 (shown in FIG. 11). High speed crossover spoke 159 is optically coupled to bus spoke 158 and is configured to connect with a non-contact optical connection of another tactical rail, e.g., to second receiver end non-contact optical connection 155 (shown in FIG. 11).

Non-contact optical connection 156 is similar to muzzle end non-contact optical connection 148 (shown in FIG. 10) and is additionally connected to left rail spoke 158. Left rail spoke 158 is configured for connecting to second receiver end non-contact optical connection 155 (shown in FIG. 10). As will be appreciated by those of skill in the art in view of the present disclosure, left rail spoke 158 and left tactical rail non-contact optical connection 156 allow for communication of high speed data D between user interface accessory 28 (shown in FIG. 10) and an accessory removably fixed at muzzle end 130 of left tactical rail 104. As shown in FIG. 13, left rail spoke 158 can include two optical waveguides, allowing user interface accessory 28 and another accessory to send and receive high speed data between one another at the same time through left rail spoke 158.

A contact electrical connection 160 is co-located with non-contact optical connection 156 at muzzle end 130. Left rail bus segment 162 is electrically connected to contact electrical connection 160 and is configured for electrical connection with power source 48 (shown in FIG. 10) through upper tactical rail 102 (shown in FIG. 10). In certain embodiments left rail bus segment 162 also communicates low speed data d between user interface 28 and an accessory removably fixed at muzzle end 130 through receiver end contact electrical connection 159 and contact electrical connection 160. As shown in FIG. 13, left tactical rail 104 can have similarly have a plurality of contact electrical connections 60 arranged axially along rail body 112 between muzzle end 130 and receiver end 132. In certain embodiments contact electrical connections 60 include pogo pad-type contact electrical connections 61 comprising positive and negative contacts at a shared axial location, for example.

In certain embodiments left tactical rail 104 can have an accessory detector 192. Accessory detector 192 is co-located with non-contact optical connection 156 and muzzle end contact electrical connection 160 on muzzle end 130 of left tactical rail 104 and is configured for detecting whether an accessory is removably fixed at muzzle end 130 of left tactical rail 104. Accessory detector 192 can be arranged to communicate electrically, using low speed data communication d, with user interface accessory 28 (shown in FIG. 10) through left rail bus segment 162.

It is contemplated that accessory detector 192 have an accessory-detected state and a no accessory-detected state. In the no accessory-detected state accessory detector 192 prevents optical communication between second receiver end non-contact optical connection 155 and non-contact optical connection 156 to prevent light conveyed through left rail spoke 158 from injuring a user. In the accessory-detected state accessory detector 192 allows optical communication between second receiver end non-contact optical connection 155 and non-contact optical connection 156. In the no accessory-detected state accessory detector 192 prevents optical communication through non-contact optical connection 156. Accessory detector 192 can be implemented with, for example, a hall-effect sensor, a pressure sensor, or a proximity sensor by way of non-limiting example, the sensor triggering communication or ceasing communication upon changing between accessory-detected and no accessory-detected state.

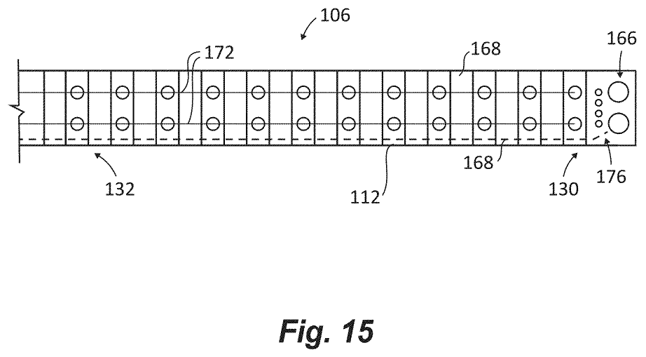

With reference to FIGS. 14 and 15, right tactical rail 106 is shown. Right tactical rail 106 is also similar to upper tactical rail 102 (shown in FIG. 1) and additionally has a rail body 112 arranged to attach to weapon right side 22 (shown in FIG. 9) and a single non-contact optical connection 166. Rail body 112 extends between a muzzle end 130 and receiver end 132. Non-contact optical connection 166 is arranged at muzzle end 130 and is configured to interface with a corresponding non-contact optical interface, e.g., optical interface 44 of accessory 24.

Non-contact optical connection 166 is optically coupled to right rail spoke 168. Right rail spoke 168 in turn is configured for connecting to third receiver end non-contact optical connection 157 (shown in FIG. 10) via a crossover spoke. As will be appreciated by those of skill in the art in view of the present disclosure, connection of third receiver end non-contact optical connection 157 with non-contact optical connection 166 allows for communication of high speed data D between user interface accessory 28 (shown in FIG. 10) and accessory 24 when removably fixed at muzzle end 130 of right tactical rail 106.

A contact electrical connection 176 is co-located with non-contact optical connection 166 at muzzle end 130. Right rail bus segment 172 is electrically connected to contact electrical connection 176 and is configured for electrical connection with power source 48 (shown in FIG. 10) through upper tactical rail 102 (shown in FIG. 10) via a bus crossover segment. In certain embodiments right rail bus segment 172 is also configured to communicate low speed data d between user interface accessory 28 and accessory 24 through receiver end contact electrical connection 159.

Right tactical rail 106 can have an accessory detector 194. Accessory detector 194 is co-located with non-contact optical connection 166 and muzzle end contact electrical connection 176 on muzzle end 130 of left tactical rail 104 and is configured for detecting whether an accessory is removably fixed at muzzle end 130 of left tactical rail 104. Accessory detector 194 can be arranged to communicate electrically, using low speed data communication d, with user interface accessory 28 (shown in FIG. 10) through right rail bus segment 172, whether an accessory is removably fixed to muzzle end 130 using an accessory-detected state and a no accessory-detected state as described above.

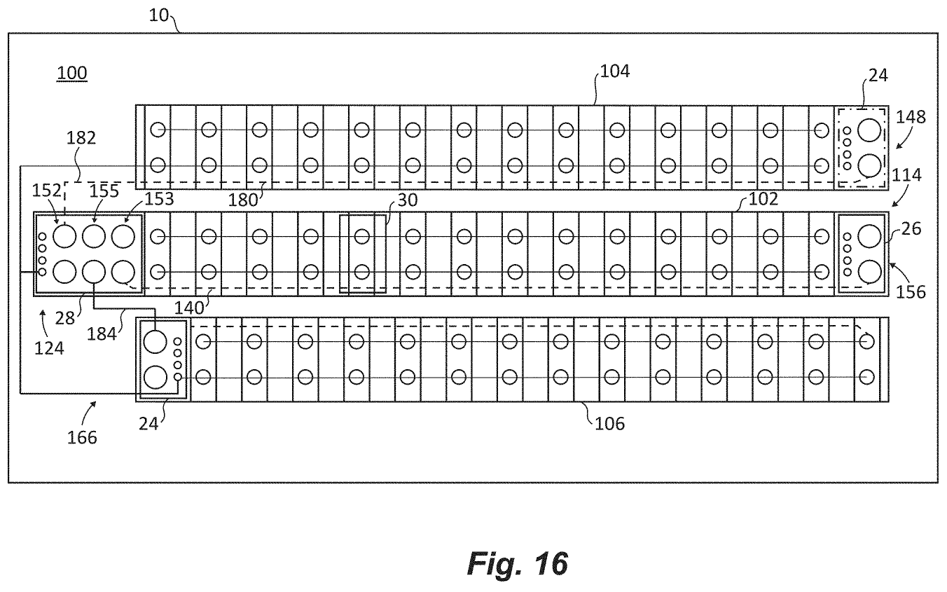

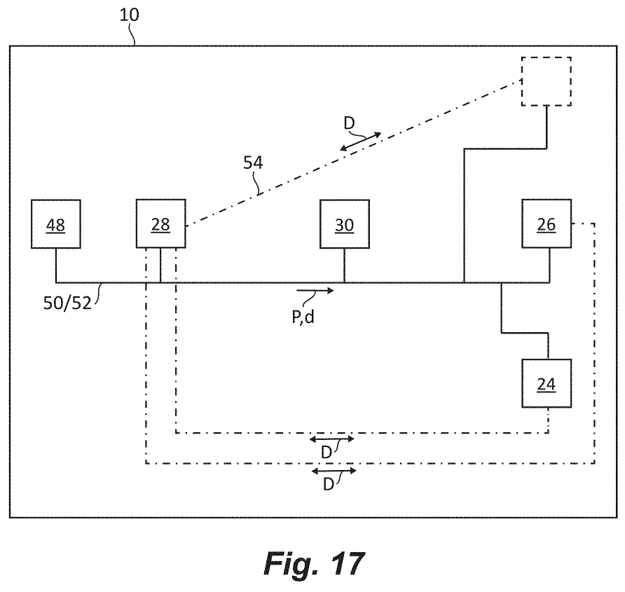

With reference to FIGS. 16 and 17, tactical rail arrangement 100 is shown according to an exemplary embodiment. Tactical rail arrangement 100 includes upper tactical rail 102 and either (or both) of left tactical rail 104 and right tactical rail 106. Upper tactical rail 102, left tactical rail 104, and right tactical rail 106 each have non-contact optical connections 60 and contact electrical connections 148/153/155/156/157/166 as described above. The contact electrical connections 60 are electrically connected to one another to define low speed bus 52 and the non-contact optical connections are optically coupled to one another to define high speed bus 54. High speed bus 54 is disposed in communication with low speed bus 52 to through user interface accessory 28, which serves a gateway terminal of low speed bus 52 and a hub of high speed bus 54 to define hybrid bus 74.

Non-contact optical connection 148 of upper tactical rail 102 is arranged at muzzle end 114 of upper tactical rail 102. First receiver end non-contact optical connection 153, second receiver end non-contact optical connection 155, and third receiver end non-contact optical connection 157 are arranged at receiver end 124 of upper tactical rail 102. High speed data spoke 140 of upper tactical rail 102, which is a rail spoke extending between muzzle end 114 and receiver end 124 of upper tactical rail 102, optically couples muzzle end non-contact optical connection 148 with first receiver end non-contact optical connection 155.

Non-contact optical connection 156 of left tactical rail 104 is arranged at muzzle end 122 or left tactical rail 102. High speed data spoke 158 includes a rail spoke 180 and a crossover spoke 182, optically coupled to one another, which both optically couple non-contact optical connection 156 to second receiver end non-contact optical connection 155. In the illustrated exemplary embodiment non-contact optical connection 166 of right tactical rail 106 is arranged at receiver end 132 of right tactical rail 106, and is optically coupled to third receiver end non-contact optical connection 157 of upper tactical rail 102 through high speed data spoke 168, which as illustrated in FIG. 16 is optically coupled through a crossover spoke 168. As will be appreciated by those of skill in the art in view of the disclosure, the illustrated exemplary arrangement allows positioning accessories, e.g. accessory 24, at the receiver end of firearm 12 to manage the center of gravity of firearm assembly 10.

The methods and systems of the present disclosure, as described above and shown in the drawings, provide for tactical rails, tactical rail arrangements, and firearm assemblies having tactical rail arrangements with superior properties including the capability to provide bandwidth suitable for high speed data communications to accommodate future data and video bandwidth requirements. For example, gigabit per second data communication can be provided with an optical high speed data spoke, and in certain embodiments, the optical high speed data spoke supplemented by a low speed wired data bus with 100-200 megabit per second low speed electrical data communications capability. The methods and systems of the present disclosure can also, in certain embodiments, provide bandwidth suitable for high speed data communication without permanently mounting electronics, e.g., PCB structures and/or integrated circuits, within the tactical rails or elsewhere on the firearm assembly. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A tactical rail for a firearm, comprising:
a rail body having a receiver end and a muzzle end;
a non-contact optical connection arranged at an end of the rail body and configured to interface with a corresponding non-contact optical interface;
a low speed data bus segment extending between the receiver end and the muzzle end of the rail body; and
a high speed data spoke connected to the non-contact optical connection for high speed data communication with a high speed data accessory through the non-contact optical connection and the corresponding non-contact optical interface.

2. The tactical rail as recited in claim 1, further comprising a power source electrically connected to the low speed data bus segment.

3. The tactical rail as recited in claim 1, further comprising a user interface accessory electrically connected to the low speed data bus.

4. The tactical rail as recited in claim 3, wherein the user interface accessory is optically coupled to the high speed data spoke by the non-contact optical connection.

5. The tactical rail as recited in claim 3, wherein the user interface includes an optical switch for switching high speed data between a plurality of high speed data spokes.

6. The tactical rail as recited in claim 1, wherein the low speed data bus segment includes a plurality of electrical conductors extending between the muzzle end and the receiver end of the rail body.

7. The tactical rail as recited in claim 1, where the low speed data bus segment includes a plurality of contact electrical connectors arranged axially between the muzzle end and the receiver end of the rail body.

8. The tactical rail as recited in claim 7, wherein the plurality of contact electrical connectors includes a pair of pogo pad-type contact electrical connectors arranged at a common axial location between the muzzle end and the receiver end of the rail body.

9. The tactical rail as recited in claim 1, wherein the high speed data spoke includes an optical waveguide.

10. The tactical rail as recited in claim 1, wherein the high speed data spoke includes a fiber optic or fiber optic bundle, a glass light pipe, or a plastic light pipe.

11. The tactical rail as recited in claim 1, further comprising an accessory detector co-located with the non-contact optical connection.

12. The tactical rail as recited in claim 1, further comprising a contact electrical connection co-located with the non-contact optical connection and electrically connected to the bus segment.

13. A tactical rail arrangement for a firearm, comprising:
upper and at least a left or right tactical rails as recited in claim 1, wherein the non-contact optical connection of the upper tactical rail is arranged on the muzzle end of the upper tactical rail,
wherein the upper tactical rail includes first and second receiver end non-contact optical connections,
wherein the upper tactical rail high speed data spoke optically couples the muzzle end non-contact optical connection with the first receiver end non-contact optical connection of the upper tactical rail, and
wherein the high speed data spoke of the left or right tactical rail optically couples the non-contact optical connection of the left or right tactical rail to the second receiver end non-contact optical connection of the upper tactical rail.

14. The tactical rail arrangement as recited in claim 13, wherein the low speed data bus segment of the left or right tactical rail is electrically connected to the low speed data bus segment of the upper tactical rail.

15. The tactical rail arrangement as recited in claim 13, further comprising a user interface accessory electrically connected to the slow speed data bus segment of the upper tactical rail and the slow speed data bus segment of the left or right bus segment, wherein the user interface accessory is optically coupled to the first and second receiver end non-contact connections of the upper tactical rail.

16. The tactical rail arrangement as recited in claim 13, the upper tactical rail further comprising:
a contact electrical connection co-located with the upper tactical rail receiver end non-contact optical connection;
a contact electrical connection co-located with the upper tactical rail muzzle end non-contact optical connection; and
a plurality of contact electrical connections arranged between the receiver end and the muzzle end of the upper tactical rail,
wherein the low speed data bus segment electrically connects the contact electrical connection co-located with the upper tactical rail receiver end non-contact optical connection, the contact electrical connection co-located with the upper tactical rail muzzle end non-contact optical connection, and the plurality of contact electrical connections arranged between the receiver end and the muzzle end of the upper tactical rail with one another.

17. The tactical rail arrangement as recited in claim 13, the left or right tactical rail further comprising:
a contact electrical connection co-located with the left or right tactical rail non-contact optical connection; and
a plurality of contact electrical connections arranged between the receiver end and the muzzle end of the left or right tactical rail,
wherein the low speed data bus segment of the left or right tactical rail electrically connects the contact electrical connection co-located with the left or right tactical rail non-contact optical connection and the a plurality of contact electrical connections arranged between the receiver end and the muzzle end of the left or right tactical rail.

18. A firearm assembly, comprising:
a firearm having a muzzle and a receiver;
a tactical rail as recited in claim 1, wherein the tactical rail is fixed to the firearm between the muzzle and the receiver of the firearm, wherein the non-contact optical connection is arranged at the receiver end of the tactical rail, the tactical rail further comprising:
a muzzle end non-contact optical connection arranged at the muzzle end of the rail body, wherein the high speed data spoke connects the muzzle end non-contact optical connection with the receiver end non-contact optical connection; and
a high speed data user interface accessory removably fixed at the receiver end of the tactical rail and in optical communication with the muzzle end non-contact optical connection through the receiver end non-contact optical connection.

19. The firearm assembly as recited in claim 18, further comprising a high speed data accessory removably fixed to muzzle end of the rail body, wherein the accessory is optically coupled to the user interface accessory by the high speed data spoke, wherein the accessory is electrically connected to the user interface accessory by the low speed data bus segment.

20. The firearm assembly as recited in claim 18, further comprising a low speed data accessory removably fixed to the tactical rail between the receiver end and the muzzle end of the rail body, wherein the low speed data accessory is electrically connected to the user interface accessory by the low speed data bus segment.
